(19) United States
(12) Patent Application Publication
(10) Pub. No.: US 2008/0080590 A1
(43) Pub. Date: Apr. 3, 2008

(54) Clinical thermometer equipped with function of reminding timely medication-taking

(75) Inventor: Wei-Chin Chen, Taipei (TW)

Correspondence Address: BIRCH STEWART KOLASCH & BIRCH, PO BOX 747, FALLS CHURCH, VA, 22040-0747, US

(73) Assignee: SPEADA INDUSTRIAL CO., LTD.

(21) Appl. No.: 11/540,675

(22) Filed: Oct. 2, 2006

(51) Int. Cl. G01K 7/00

(52) U.S. Cl. 374/163

(57) ABSTRACT

A clinical thermometer equipped with function of reminding timely medication-taking includes a clinical thermometer that has a control unit which has a circuit board. The circuit board has a switch, input button keys, a buzzer and a display unit exposed on the clinical thermometer to display measured body temperature. The clinical thermometer also provides a ringer function. The clinical thermometer further has a plurality of housing portions on one end to hold medication. Aside from measuring the body temperature, it can also hold the medication and remind users to take the medications timely.

### FIELD OF THE INVENTION

The present invention relates to a clinical thermometer equipped with function of reminding timely medication-taking and particularly to a clinical thermometer that not only can measure temperature also can hold medications and remind users to take the medications.

### BACKGROUND OF THE INVENTION

With advance of civilization and technology, people in the modern society have a greater awareness on health and diets. Many people also are used to take vitamins or health improving food stuffs regularly. However people often have to devote full attention to the work and forget to take medication timely. Moreover, many people also suffer from chronic illness. Forgetting to take medication timely makes healing or ill-containment more difficult. This is a non-desirable situation most patients trying to avoid. To address this issue, many drug containers equipped with a timer or reminder to alert patients to take medication have been developed. For instance, the applicant submitted a technique in R.O.C. patent publication No. 557867 which is a pen equipped with a function to remind timely medication-taking. It includes a pen set which has a buzzer and a plurality of containers to carry medications. While incorporating the pen with medication carrying function is convenient, it is not widely accepted by the general public.

Many medications such as those for treating influenza or unwell body condition must be taken only after the body temperature has been measured. This is especially true for children and old people, as their reaction to the body temperature is not as sensitive as the ordinary people do. A clinical thermometer usually is needed to take the temperature. Hence taking the clinical thermometer and medication box at the same time is a commendable approach. In 2003, SARS (severe acute respiratory syndrome) spread widely and seriously. It caused a panic worldwide. Taiwan also was listed in the high risk areas. The early symptom of SARS is a higher body temperature. Hence taking body temperature becomes the first guard against SARS. In 2005 Avian Influenza become another worldwide concern. Its symptom is similar to the influenza. Body temperature has to be taken to detect abnormal physical conditions. While the situation is under control now, the general public has different awareness for the importance of measuring body temperature, the requirement for the clinical thermometer is higher. If body temperature and medications can be obtained at the same time, it is more convenient for users. Providing reminding function for medication-taking also enables users to take medication at the optimal time.

### SUMMARY OF THE INVENTION

Therefore the primary object of the present invention is to provide a solution to meet the aforesaid requirements.

The present invention aims to provide a clinical thermometer equipped with function of reminding timely medication-taking, and especially a clinical thermometer that provides functions of holding medications, reminding medication-taking and measuring body temperature.

The clinical thermometer according to the invention includes a clinical thermometer which has a control unit and a power supply unit. The control unit has a circuit board which includes a plurality of input button keys, a switch and a display unit. The input button keys aim to provide functions of time-setting and reminding of medication-taking. The switch aims to control the power supply of the clinical thermometer. The power supply unit is electrically connected to the control unit to provide electric power needed. In addition, the clinical thermometer also has a plurality of housing portions to carry required medications. By means of the invention, users can set by themselves medication-taking time, and carry the required medications. It is small size and easy to carry, and can be used to take body temperature whenever needed to determine a desirable time to take the medications.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the invention.

FIG. 2 is an exploded view of an embodiment of the invention.

FIG. 3 is a sectional view of an embodiment of the invention.

FIG. 4 is an exploded view of another embodiment of the invention.

### DETAILED DESCRIPTION OF THE PREFERRED EMBODIMENTS

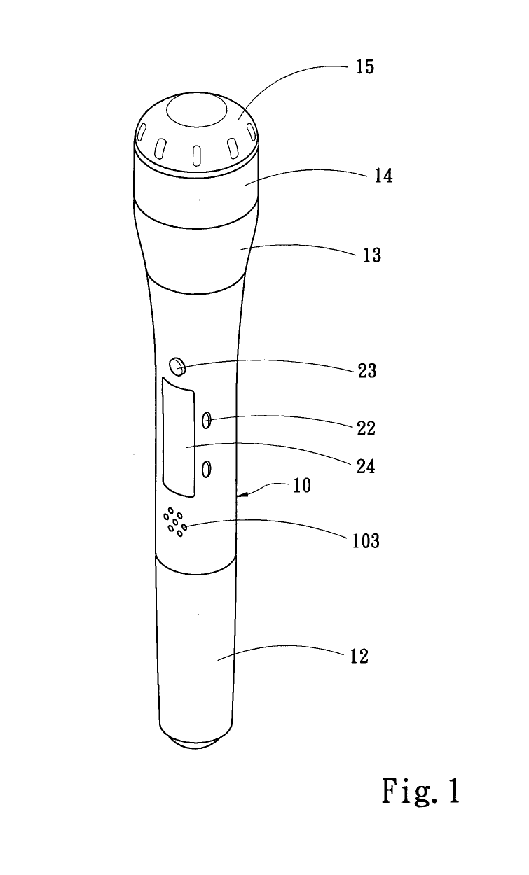

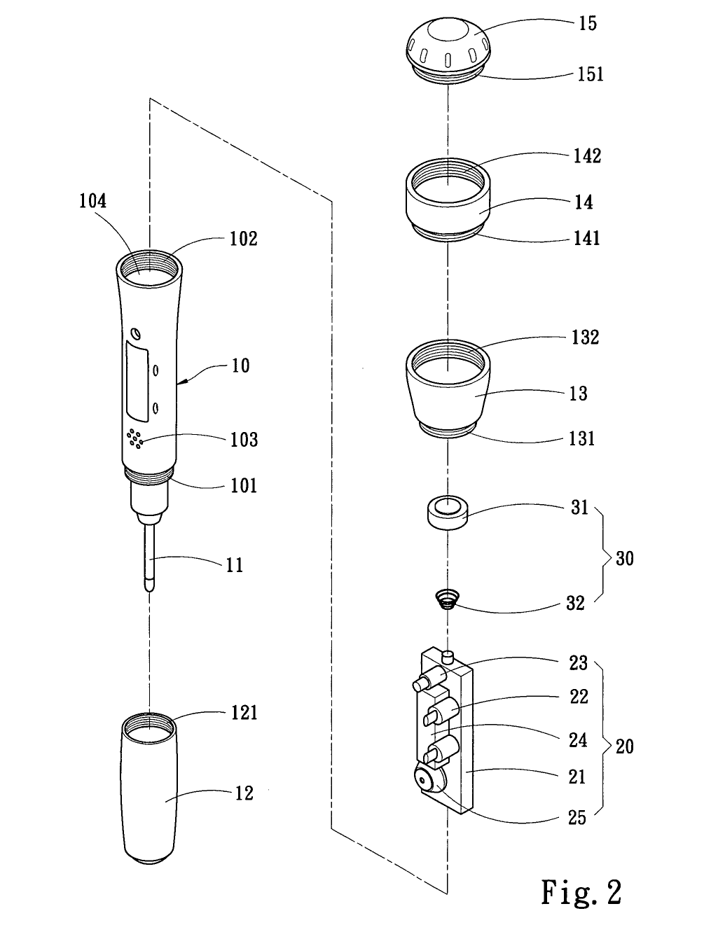

Please refer to FIGS. 1 and 2 for an embodiment of the invention. The clinical thermometer according to the invention includes a clinical thermometer 10, a control unit 20 and a power supply unit 30. The clinical thermometer 10 has a housing chamber 104 to hold the control unit 20 and the power supply unit 30. The control unit 20 includes a circuit board 21 which provides timing alert and ringer functions that are known in the art. The circuit board 21 is located on the clinical thermometer 10, and has a switch 23, a plurality of input button keys 22, a buzzer 25 and a display unit 24. The switch 23 aims to control power supply of the clinical thermometer 10. The input button keys 22 aim to set time and ringer to remind medication-taking. The buzzer 25 can generate sound at the setting time to remind users to take medication. The clinical thermometer 10 further has a plurality of apertures 103 to broadcast the sound generate by the buzzer. The display unit 24 is exposed on the clinical thermometer 10 to display time and remind medication-taking. The power supply unit 30 includes a battery 31 and a conductive element 32 (may be an elastic reed or a conductive blade depending on requirements). The battery 31 is connected to the control unit 20 through the conductive element 32 to provide required electric power.

The clinical thermometer 10 has a sensor end 11 on one end to measure body temperature. It has a first annular threaded portion 101 with an external screw thread formed thereon. It also has a guarding cap 12 which has an opening 121 with an annular internal screw thread formed thereon. The opening 121 can be coupled with the first annular threaded portion 101 to enable the guarding cap 12 to cover the sensor end 11 to provide protection.

The clinical thermometer 10 has a first housing portion 13 on one end. The first housing portion 13 is coupled with a second housing portion 14 and an upper cap 15 which covers a tail end of the second housing portion 14. Coupling of various elements of the clinical thermometer is discussed as follow. The clinical thermometer 10 further has a second annular threaded portion 102 on another end that has an annular internal screw thread. The first housing portion 13 has a first coupling portion 131 with an annular external screw thread formed thereon corresponding to and engageable with the second annular threaded portion 102. The first housing portion 13 further has a second coupling portion 132 with an annular internal screw thread formed thereon. The second housing portion 14 has a first connecting portion 141 with an annular external screw thread formed thereon corresponding to and engageable with the second coupling portion 132 of the first housing portion 13. The second housing portion 14 has a second connecting portion 142 with an annular internal screw thread formed thereon. The upper cap 15 has a upper connecting portion 151 with an annular external screw thread formed thereon corresponding to and engageable with the second connecting portion 142 of the second housing portion 14.

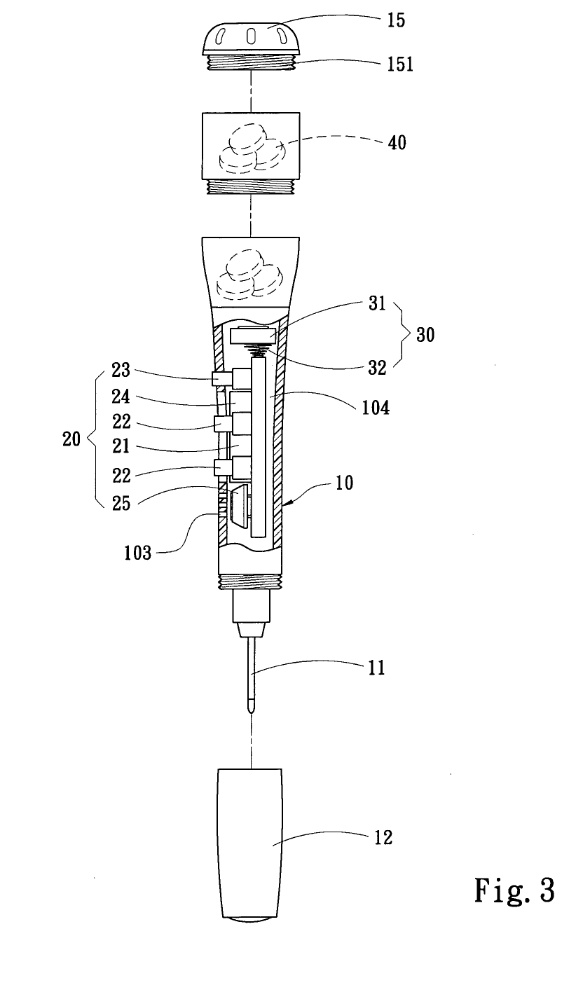

Referring to FIG. 3, when in use, the first housing portion 13 and the second housing portion 14 can hold medication 40. The upper cap 15 can cover the second housing portion 14 to prevent the medication 40 from dropping out.

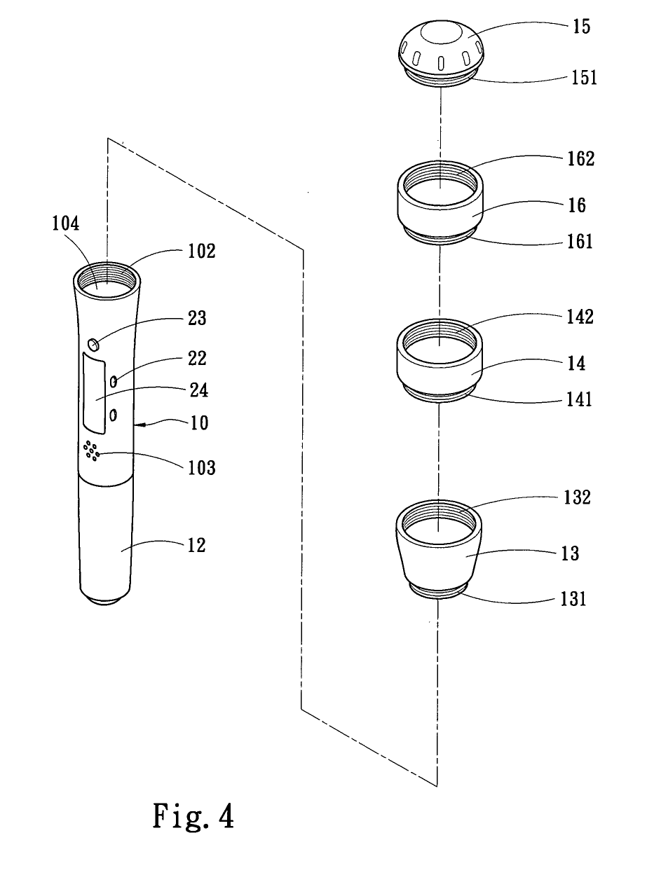

Refer to FIG. 4 for a second embodiment of the invention. Depending on actual requirements, a third housing portion 16 may be added that has a first fastening portion 161 with an annular external screw thread formed thereon and a second fastening portion 162 with an annular internal screw thread formed thereon to be coupled with the clinical thermometer 10 to increase the amount of medication to be carried.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A clinical thermometer equipped with function of reminding timely medication-taking, comprising:
a clinical thermometer which has a housing chamber and a first housing portion on one end, the first housing portion being coupled with a second housing portion and an upper cap which covers a tail end of the second housing portion;
a control unit which is held in the housing chamber to display time and generate sound to remind medication-taking, and includes a circuit board which is located on the clinical thermometer and has a switch, a plurality of input button keys, a buzzer and a display unit exposed on the clinical thermometer; and
a power supply unit which includes a battery and a conductive element, the battery being connected to the control unit through the conductive element to provide electric power needed.

2. The clinical thermometer of claim 1, wherein the clinical thermometer has a plurality of apertures to broadcast sound generated by the buzzer.

3. The clinical thermometer of claim 1, wherein the clinical thermometer includes a sensor end and a guarding cap to cover the clinical thermometer to protect the sensor end.

4. The clinical thermometer of claim 1, wherein the circuit board of the control unit has a ringer function to remind medication-taking.

5. The clinical thermometer of claim 1, wherein the clinical thermometer has a second annular threaded portion which has an annular internal screw thread formed thereon, the first housing portion having a first coupling portion which has an annular external screw thread formed thereon corresponding to and engageable with the second annular threaded portion.

6. The clinical thermometer of claim 1, wherein the first housing portion has a second coupling portion which has an annular internal screw thread formed thereon, the second housing portion having a first connecting portion which has an annular external screw thread formed thereon corresponding to and engageable with the second coupling portion of the first housing portion.

7. The clinical thermometer of claim 1, wherein the second housing portion has a second connecting portion which has an annular internal screw thread formed thereon, the upper cap having an upper connecting portion which has an annular external screw thread formed thereon corresponding to and engageable with the second connecting portion of the second housing portion.

8. The clinical thermometer of claim 1 further having a third housing portion which has a first fastening portion that has an annular external screw thread formed thereon and a second fastening portion that has an annular internal screw thread formed thereon that are coupled in series with the clinical thermometer to increase the amount of medication to be carried.
